(19) United States
(12) Patent Application Publication
(10) Pub. No.: US 2005/0021384 A1
(43) Pub. Date: Jan. 27, 2005

(54) Capacity planning method and system with approved accuracy and confidence indication

(75) Inventors: Bridget Pantaleo, Scotch Plains, NJ (US); Summer Fischer, North Haledon, NJ (US); Faye Abad Franzone, New York, NY (US); Pankaj Sharma, Edison, NJ (US); Veeraraghavan Sampath, TamilNadu (IN); Gerald L. Gregorio, Staten Island, NY (US); Edward Piscina, Staten Island, NY (US)

Correspondence Address: McDERMOTT, WILL & EMERY, 600 13th Street, N.W., Washington, DC, 20005-3096, US

(73) Assignee: Pershing Investments, LLC

(21) Appl. No.: 10/870,922

(22) Filed: Jun. 21, 2004

Related U.S. Application Data
(63) Continuation-in-part of application No. 10/725,205, filed on Dec. 2, 2003.
(60) Provisional application No. 60/430,054, filed on Dec. 2, 2002.
(60) Provisional application No. 60/445,850, filed on Feb. 10, 2003.

(51) Int. Cl. G06F 17/60

(52) U.S. Cl. 705/9

(57) ABSTRACT

A capacity planning method and system that dynamically determine staff capacity based on staff availability, work schedule, and holdover information, also provides a confidence indication to assist determination of report accuracy. The system calculates a workload of a task, and the amount of time or the number of staff needed to perform the tasks. A capacity report is generated based on the workload and staff availability. The task includes data obtained or generated from different sources and/or various methods. Respective trustworthiness scores associated with the data obtained or generated from different sources and/or methods are obtained to calculate an index of confidence indicating the reliability of information included in the capacity report.

### RELATED APPLICATIONS

This application is a continuation-in-part of U.S. patent application Ser. No. 10/725,205, titled “CAPACITY PLANNING METHOD AND SYSTEM,” filed on Dec. 2, 2003, which claimed benefit of priority from U.S. Provisional Patent Application Ser. No. 60/430,054, titled “Capacity Planning System and Method,” filed Dec. 2, 2002; and from U.S. Provisional Patent Application Ser. No. 60/445,850, titled “System, Method, Network and Software Tool for Capacity Planning,”filed Feb. 10, 2003. Disclosures of the above-identified patent applications are incorporated herein by reference in their entireties.

### FIELD OF DISCLOSURE

This disclosure generally relates to an improved method and system for capacity analysis and forecasting, and more specifically, to a capacity planning method and system that dynamically determine staff capacity based on staff availability, work schedule, and holdover information, and provide a confidence indication to assist determination of report accuracy.

### BACKGROUND OF THE DISCLOSURE

In an organization where numerous complex tasks are performed, such as a bank, a clearing firm, a clearing center, or an insurance company, it is important to know whether the capacity of the organization is sufficient to handle the number of incoming tasks. If not, additional resources need to be allocated and/or assigned, such as by bringing in part-time or temporary workers, extending work hours, borrowing staff from other departments, etc., in order to perform the tasks as required in the appropriate timeframe.

Basic capacity management systems are used in some call centers to plan and manage personnel. Such a system typically enables a call center to determine the number of agents needed to service incoming calls based on historic data of incoming calls. Some systems may further include a scheduling capability to allocate agent work hours according to the historic data of incoming calls. For example, more agents are assigned to peak hours during the day. Such a capacity management system is built based on the assumptions that the type and number of tasks to be performed, and the amount of time needed to perform the tasks are statistically fixed or unchanged. For example, in a call center, the major tasks to be performed are answering incoming calls. The variance of the amount of time needed to service each incoming call is minimal. Using such assumptions, conventional capacity management systems may determine the number of agents needed by dividing the number of hourly incoming calls by the number of calls an agent can handle each hour.

However, such conventional capacity management systems are not suitable for organizations that perform complex tasks. Complex tasks usually involve different types of subtasks with various difficulties that need to be handled by employees. The amount of time needed to perform each subtask is usually different. In addition, employees in the organizations hold different positions and thus spend different amount of time on functions other than handling the complex tasks. Such functions may include management, training, administration, etc. The primitive model used in conventional capacity planning systems does not have the ability to address such complexity.

In addition, conventional capacity planning systems fail to address the problem of holdover tasks. Holdover tasks generally refer to tasks assigned before a specific input time, but are not yet performed and/or completed by a cutoff time. For example, after one or more tasks are assigned to a department in a company, that department may be, for whatever reasons, unable to perform the tasks as required or planned, and defer completion of such tasks to a later time. Consequently, that department needs to dedicate certain capacities to perform the holdover tasks at a later time. These capacities dedicated to the holdover tasks cannot be used to handle new incoming tasks. The capacity planning system needs to capture the amount of holdover tasks when it evaluates available resources to handle new incoming works.

Moreover, incoming tasks usually include data entered or generated from different data sources using various data input methods including manual input, systematic data transfer, automatic data generation, etc. Data collected from one data source or using one input method, such as manual input, may be less reliable or trustworthy than that collected from other data sources or using other input methods, and thus needs additional resources to improve the data. Conventional capacity planning systems do not address these possible discrepancies between data, and thus fail to correctly estimate the needed capacity to perform the tasks.

### SUMMARY OF THE DISCLOSURE

This disclosure presents an improved capacity planning method and system that provide numerous advantages that will be appreciated and understood from the following descriptions. One advantage is that holdover tasks are considered when calculating needed resources. Another advantage is that a confidence index indicating data confidence from various data sources is provided, such that a reviewer may determine the correctness or reliability of a capacity report based on the confidence index.

An exemplary capacity planning technique determines the amount of work to be performed by an organization, and determines whether the organization has sufficient staff to perform the tasks. In one aspect, the tasks include at least one holdover task, i.e., a task that was previously assigned, but not yet performed and/or completed by a cutoff time. A workload is calculated based on the amount and types of tasks, and the amount of time or the number of staff needed to perform the tasks. The method then determines staff availability based on staff information related to the number of employees, identities and positions of employees, exempt status of employees, staff outage, the amount of work time that cannot be used to perform the subtasks, and/or the amount of business days. A capacity report is then generated based on the workload and the staff availability.

According to one embodiment, the tasks to be performed by the organization include data obtained or generated from different sources and/or various methods. A trustworthiness score associated with the data is obtained to calculate an index of confidence of information included in a capacity report generated for the tasks. The trustworthiness score may be assigned empirically, such as based on the source of data intake and/or a method used to generate the data, such as manual input, systematic data transfer, automatic data generation, etc.

In one example, a task includes a plurality of subtasks. An index of confidence for the task is calculated based on normalized trustworthiness scores of the subtasks included in the task. For instance, for each subtask, a relative workload is determined by dividing the workload of the subtask by the total workload of the task. A normalized trustworthiness score for each subtask is calculated based on the respective trustworthiness score of each subtask, and the respective relative workload of each subtask. In one aspect, the normalized trustworthiness score for each subtask is generated by multiplying the respective trustworthiness score of each subtask by the respective relative workload of each subtask. An index of confidence for the task is generated by combining the normalized trustworthiness score of the subtasks included in the task. For example, the normalized trustworthiness score of the subtasks included in the task are added to generate an overall index of confidence for the estimations related to the task, such that a reviewer of the capacity report may determine the correctness or confidence of a capacity report based on the confidence indices.

A data processing system, such as a computer, may be used to perform capacity planning as described herein. The data processing system may include a processor for processing data and a data storage device coupled to the processor, and data transmission means. The data storage device bearing instructions to cause the data processing system upon execution of the instructions by the processor to perform functions as described herein. The instructions may be embedded in a machine-readable medium to control the data processing system to perform capacity planning. The machine-readable medium may include optical storage media, such as CD-ROM, DVD, etc., magnetic storage media including floppy disks or tapes, and/or solid state storage devices, such as memory card, flash ROM, etc. Such instructions may also be conveyed and transmitted using carrier waves.

Still other advantages of the presently disclosed methods and systems will become readily apparent from the following detailed description, simply by way of illustration of the invention and not limitation. As will be realized, the capacity planning method and system are capable of other and different embodiments, and their several details are capable of modifications in various obvious respects, all without departing from the disclosure. Accordingly, the drawings and description are to be regarded as illustrative in nature, and not as restrictive.

### BRIEF DESCRIPTIONS OF THE DRAWINGS

The accompanying drawings, which are incorporated in and constitute a part of the specification, illustrate exemplary embodiments.

FIG. 1 is a schematic block diagram depicting an exemplary architecture of an exemplary capacity planning system.

FIG. 2a illustrates a data input that enters data into the capacity planning system.

FIGS. 2b-2g show exemplary data structures used in a capacity planning system.

FIGS. 3a and 3b show flow charts illustrating operations of the exemplary capacity planning system, and calculation of normalized trustworthiness scores.

FIGS. 4a-4d depict an example of a capacity report generated by the exemplary capacity planning system.

FIG. 5 shows a schematic block diagram of a data processing system upon which an exemplary capacity planning system of this disclosure may be implemented.

### DETAILED DESCRIPTIONS OF ILLUSTRATIVE EMBODIMENTS

In the following description, for the purposes of explanation, numerous specific details are set forth in order to provide a thorough understanding of the present disclosure. It will be apparent, however, to one skilled in the art that the present method and system may be practiced without these specific details. In other instances, well-known structures and devices are shown in block diagram form in order to avoid unnecessarily obscuring the present disclosure.

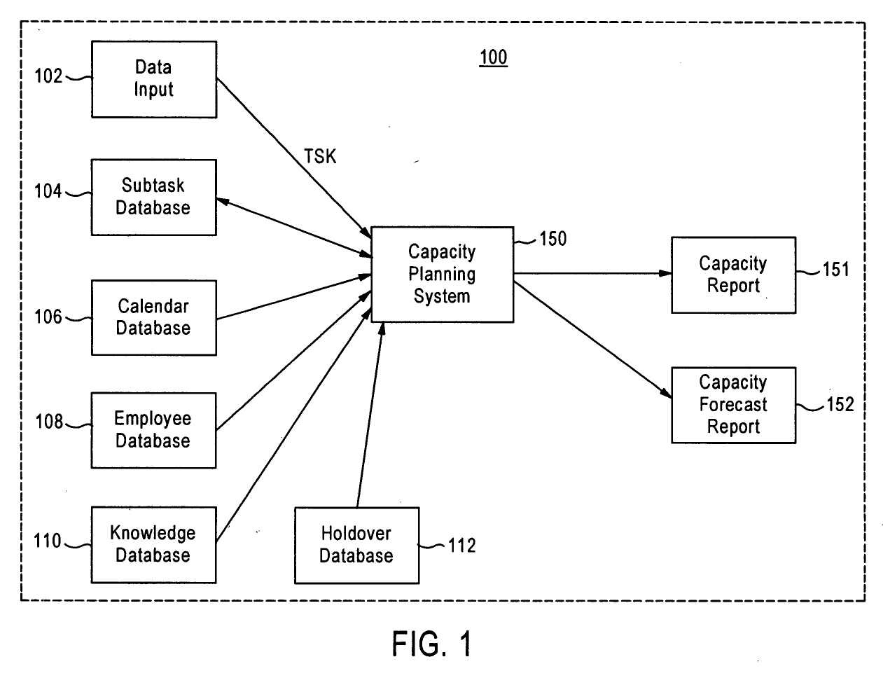

In FIG. 1, an exemplary capacity planning architecture 100 is shown. An exemplary capacity planning system 150 is provided to generate capacity reports to show the status of total workload and staff availability of an organization, such as a clearing firm. The capacity planning system 150 has access to information from various data sources, such as a data input 102, a subtask database 104, a calendar database 106, an employee database 108, a knowledge database 110, and a holdover database 112. Based on the obtained information, the capacity planning system 150 generates capacity reports 151 (which may include one or more reports) for the organization for a specific period of time. The capacity planning system 150 may also generate forecast reports 152 (which may include one or more reports) predicting future workloads and staff availability.

Box 100 represents a system of one or more data processing systems, such as computers, personal digital assistance (PDA), mobile phones, etc. The capacity planning system 150, data input 102, subtask database 104, calendar database 106, employee database 108, knowledge database 110, holdover database 112 may be implemented as software running on that system. If the system represented by box 100 is implemented using more than one data processing systems, the data processing systems may be connected to each other with a data transmission network, such as the Internet, local area network, etc. The capacity reports 151 and forecast reports 152 may be generated on a display or displays of one or more data processing systems included in the system represented by box 100. The reports may also be sent to printers, data storage devices, other data processing systems, etc. that are coupled to the system represented by box 100.

The data input 102 represents one or more terminals or points of intake for receiving data related to incoming tasks to be performed by the clearing firm. The input tasks may be of the same type or different types. The data input 102 may be an operator, a computer, a database, a server that takes orders or receives information from a data transmission network, and the like, and/or any combination thereof. The data input 102 may be formed of a plurality of terminals or points of intakes connecting as a network. Each terminal or point of intake is similar to a node in a network. One terminal or point of intake receives data from, and sends data to, other terminals or points of intake.

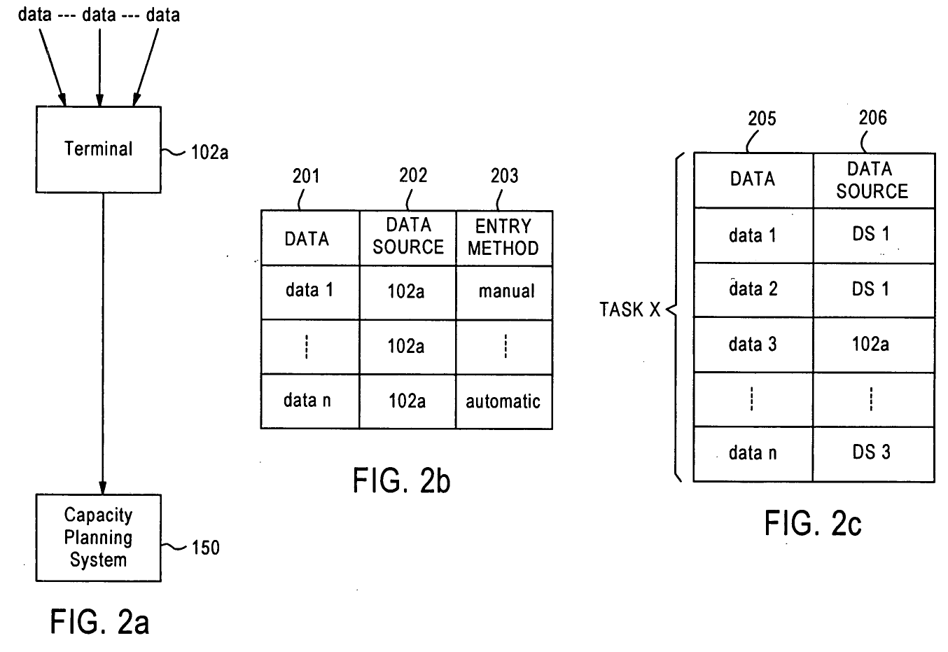

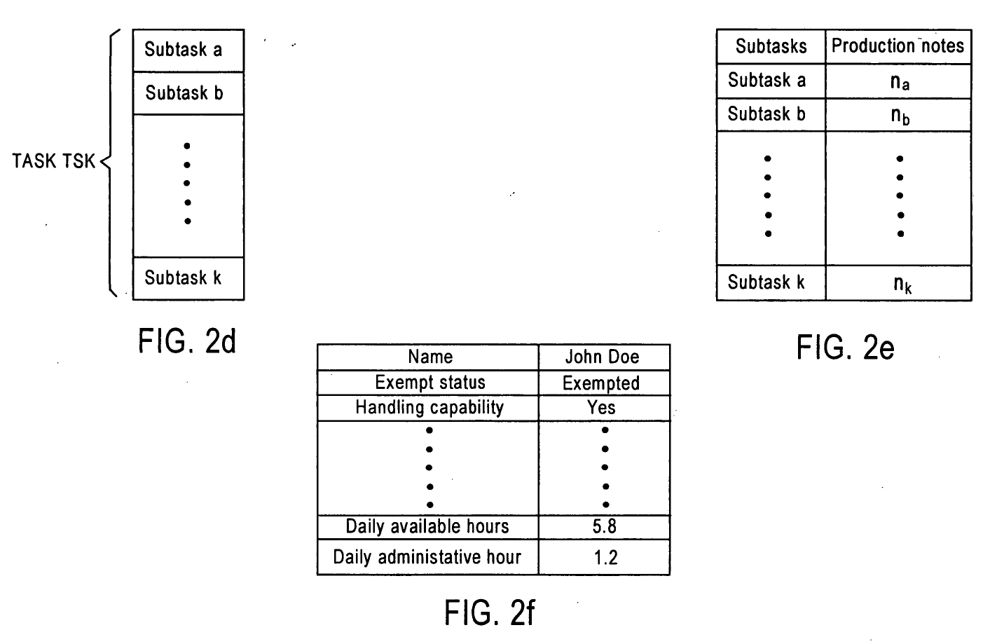

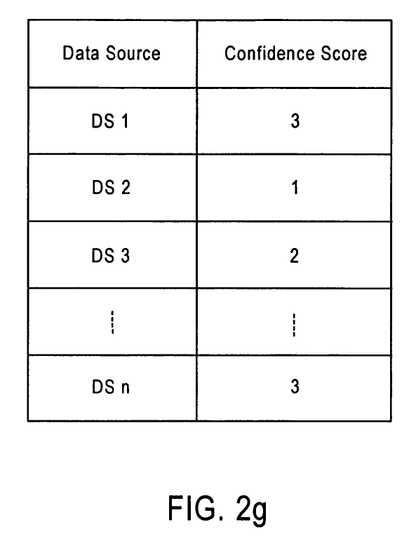

As shown in FIG. 2a, a terminal 102a, which is part of the data input 102, takes in data to be processed by the capacity planning system 150. In one embodiment, the terminal 102a is similar to an end node of a network, which only generates and sends data to the capacity planning system 150, and does not receive data from other terminals of the data input 102. In this case, all the data related to tasks to be analyzed by the capacity planning system 150 originates from the terminal 102a. The data can be manually entered or automatically generated, or a combination thereof. The terminal 102a uses a data table as shown in FIG. 2b to “tag” the generated data with its origins. In data field 201, data originated from the terminal 102a are identified. Data filed 202 identifies that the data is generated by the terminal 102a. The data table is sent to the capacity planning system 150 along with the data. The data table may provide an additional data filed 203 to identify the method by which the data is entered. For instance, some of the data may be entered manually, which is prone to errors. Other data may be entered by methods that are subject to less human error, such as computer generated reports, data inventories, client database, etc.

In another embodiment, the terminal 102a not only generates data related to tasks to be performed by the organization, but also passes or incorporates data generated from other terminals. In other words, the terminal 102 is like a gateway for data from different sources, including the terminal 102 itself, to enter into the capacity planning system 150. For instance, a specific task may include data generated from different sources. A data table as shown in FIG. 2c is used to identify the sources of data to be processed by the capacity planning system 150. Data field 205 identifies the data, and data field 206 indicates the origins of the data. As depicted in FIG. 2c, data 1 and data 2 both originate from data source DS1. Data 3 is generated by the terminal 102, and data n is generated by data source DS3. By using the data structure as illustrated in FIGS. 2b and 2c, the capacity planning system 150 is able to determine the origins of the data or the methods that are used to generated the data.

The capacity planning system 150 has access to a holdover database 112. The holdover database 112 stores information related to tasks that were previously assigned but are not yet performed or completed. For example, holdover tasks may be defined as unperformed tasks that are older than a certain age (e.g., from the date that the tasks enter the capacity planning system), or assigned before a specific time but not performed by a cutoff time. A query specifying a search criterion may be used to dynamically search for assigned but not yet performed tasks. Since these holdover tasks still need to be perform by the organization and hence will take up resources of the organization, the capacity planning system 150 needs to consider the holdover tasks in calculating the organization's capacity in performing tasks. The holdover database 112 may be one or more data storage devices storing information related to the holdover tasks. The holdover database 112 may be implemented as a logical database having data distributed in different systems. The data related to holdover tasks is identifiable by, for example, a unique ID or keyword. When needed, a search engine may be used to conduct a search on the different systems to retrieve data related to the holdover tasks.

The following embodiments use a clearing firm as an illustrative example to show the operations of the exemplary capacity planning system 150. It is to be understood that the capacity planning method and system can be used in numerous types of organizations, and the application of the capacity planning method and system is not limited to the examples shown below.

A clearing firm performs many complex tasks, such as domestic clearance, international clearance, government clearance, etc. In order to generate capacity reports of the clearing firm for a specific period of time, the capacity planning system 150 needs to determine the overall workload, i.e., the total amount of tasks needed to be performed by the clearing firm over the specific period of time, and staff availability of the clearing firm.

(1) Calculating Workload

The capacity planning system 150 identifies tasks received from the data input 102 and holdover database 112, and if a task includes more than one subtask, identifies the subtasks associated with the task. The types and amount of the subtasks are determined based on statistical data and/or empirical studies of the operation of clearing firm. For example, a task related to domestic clearance may include the following subtasks:

Balancing with Broker

Manual Bookkeeping Entries

Adjusting Customer Accounts

Managing Fails

Managing Breaks

Phone Calls

Report Preparation and Distribution

Suspense Balancing

Research

Reconciliation

Letters to SEC

And a task related to international clearance may include the following subtasks:

Managing Fails

Update Database

Reconciliation

Suspense Balancing

Phone Calls

Managing Breaks

Billing

Confirms

Allocations

Other possible subtasks associated with a task may include updating account information, entering data related to agreements, entering data related to margin accounts, entering data related to option accounts, entering data related to regulatory requirements, such as W9.

The subtask database 104 stores data related to subtasks associated with each task. The subtask database 104 may be one or a plurality of logical and/or physical databases that are local and/or remote to the capacity planning system 150. As shown in FIG. 2d, for a task TSK to be performed by the clearing firm, the subtasks associated with that task TSK are subtask a, subtask b, . . . and subtask k. Different types of tasks may include subtasks having the same names, yet the functions needed to be performed may be identical or different. The subtask database 104 may use the same subtask ID to identify identical subtasks, and different subtask IDs for different subtasks.

The subtasks associated to a specific task may be logically linked to an ID representing that task, and stored in the subtask database 104. In another embodiment, the subtask database 104 may utilize a search engine to dynamically retrieve subtasks associated with a specific task each time such information is requested by the capacity planning system 150.

As shown in FIG. 2e, the subtask database 104 further includes information related to production rates corresponding to each subtask. The production rate represents a relationship between the amount of time or the number of employees needed to perform a specific subtask. For instance, the production rate may be the number of subtasks or the number of units of a subtask that a full-time employee of the clearing firm can perform each hour. In another embodiment, the production rate may be the amount of time a full-time employee needs to perform a specific subtask. Other representations or definitions of the production rate can also be used.

The production rate corresponding to each subtask may be logically linked to each subtask ID and stored in the subtask database 104. In anther embodiment, the subtask database 104 may utilize a search engine to dynamically retrieve the production rate corresponding to each subtask every time such information is requested. The production rates may be determined by an observation or empirical studies of the clearing firm's operations to ascertain how much time an employee in the clearing firm needs to perform a specific subtask.

After the capacity planning system 150 receives a task TSK from the data input 102, the capacity planning system 150 accesses the subtask database 104 to determine the subtasks associated with the task TSK. Based on the determined subtasks, the capacity planning system 150 accesses the subtask database 104 to obtain production rates corresponding to the subtasks associated with the task TSK. The same process will be applied to each task within the specific period of time, such as one month. The total number of each subtask is then accumulated.

For holdover tasks, since they were previously processed by the capacity planning system 150 but are not finished or performed, information related to subtasks associated with the holdover tasks and corresponding production rates may have already been identified by the capacity planning system 150, and stored in the holdover database 112. For some holdover tasks, they may have been partially processed, but not completed by the cutoff time. In other words, some of the subtasks associated with the partially performed holdover tasks are performed. In that case, the holdover database 112 stores information related to the unfinished subtasks.

In order to identify holdover tasks and/or unperformed subtasks associated with partially performed holdover tasks, for each subtask to be performed by the organization, a data field is provided to indicate whether it has been performed or not. If a subtask has been performed, an appropriate flag is raised to indicate as such. By reading information associated with the data field, capacity planning system 150 can identify unfinished tasks and/or subtasks, and store such information in the holdover database 112. Alternatively, for simplicity of system design, capacity planning system 150 may assume that none of the holdover tasks was performed for purpose of calculating needed resources to handle the holdover tasks.

After the total number of subtasks associated with each task TSK and unperformed subtasks associated with each holdover task is determined, the capacity planning system 150 accesses information related to the respective production rates of the identified subtasks and holdover tasks, if any. The workload is then ascertained using the following equations:
Workload=SUM of (the total number of subtasks/the production rate thereof);
wherein:
the workload is the total number of employee work hours needed to perform all of the subtasks identified by the capacity planning system 150 and the holdover tasks, if any; and
the production rate represents the units of subtasks that an employee can perform in one hour.

Alternatively, if the production rate represents the time needed to perform each subtask, the workload (total hours needed) may be calculated by multiplying the total number of each subtask by their respective production rate.

The workload may further be adjusted to address the time spent on support functions. Support functions are routine functions that the employees need to perform, but may be related to the volume of tasks. Examples of support functions include filing, system testing, system maintenance, document retrieval, etc. The average hour needed for performing the support functions may be determined based on observation of the operations of the clearing firm. The information may be stored in the subtask database 104 and accessible by the capacity planning system 150. The adjusted workload is calculated using the following equation:
Workload=[SUM of (the total number of subtasks/the production rate thereof)]+(average daily hours for support functions*the number of days within the specific period of time)
(2) Calculating Staff Availability

In order to generate a capacity report 151 to indicate whether the clearing firm has sufficient employees to handle the incoming tasks, in addition to calculating the total workload over the specific period of time, the capacity planning system 150 needs to determine the status of staff availability based on the employees' available work hours and the total business days within that specific period of time. Information related to the number of business days of the specific period of time can be obtained from calendar database 106, which stores data related to the amount of business days and holidays of a specific period of time.

The capacity planning system 150 also accesses the employee database 108 which includes staff information related to the employees of the clearing firm, including, for example, names and positions, skill levels, types of subtasks they can perform, full-time/part-time status, exempt/non-exempt status, available overtime schedule, the amount of work time that can and cannot be used to handle subtasks, etc. An exemplary data structure related to an employee, John Doe, is depicted in FIG. 2c. As shown, John Doe is an exempt employee, which means John Doe is exempt from the hourly overtime wage. John Doe is also an exempt employee that can contribute additional hours to production if needed. John Doe uses an average of 1.2 hours each day on works other than performing the subtasks and support functions, including meeting, administrative matters, training, etc. Thus, John Doe is available to work 5.8 hour on subtasks each day based on a seven-hour work day schedule.

The staff availability can be calculated as the amount of total employee work hours. The capacity planning system 150 may calculate the total employee work hours using the following equation:
Total Work Hours=total number of full-time employees*daily work hours
The total number of employees may be determined by accessing the employee database 108. The daily work hours may be set at 7 hours or any other number of hours depending on system design. In one example, the number of daily work hours is configurable, and is dependent on the tasks to be performed, the departments in the organization, and so on.

After both the workload and staff availability are obtained, the capacity planning system 150 then generates a capacity report of the month by comparing the number of total work hours and the workload. If the workload is more than the total work hours, it means that the clearing firm does not have sufficient resources to handle all the existing tasks based on a normal seven-hour day schedule. The human resource manager may need to take certain steps, such as requiring work over-time, bringing in part-time or temporary workers, to fill the gap.

The calculation of the total work hours may be adjusted when both full-time and other types of employees, such as part-time employees, temporary employees, interns, etc., are involved. In that case, the total work hours can be calculated using the following equation:
Total Work Hours=(total number of full-time employees*daily work hours)+(total work hours of other types of employees)
Alternatively, for simplicity of calculation, if actual work hours of other types of employees are known, each part-time employee can be counted as 0.5 full-time employee. The weight for other types of employees can be determined by empirical studies or design preferences. The total work hours can be calculated using the following equation:
Total Work Hours=(total number of full-time employees+0.5*total number of part-time employees)*daily work hours

The capacity planning system 150 may improve the accuracy of the report to further consider work hours lost due to staff outage, such as sick days, personal vacations, paid/non-paid leave, disability, etc. Staff outage hours can be determined based on statistical data or historical of the clearing firm. For instance, the records for the past three years may indicate that the total hours lost per month due to staff outage are 84 hours, which is equivalent to the work time of 0.6 full-time employee. Such information may be stored in the employee database 108. The adjusted total work hours can be calculated using the following equation:
Adjusted Total work hours=Total Work Hours−Staff Outage Time;
wherein:
Staff Outage Time=(average daily hours lost due to staff outage*the number of days within the specific period of time)
In another embodiment, the staff outage time may be calculated as the actual work time lost due to staff outage for all employees during a specific period of time.

Furthermore, the available work hours can be adjusted by considering work hours borrowed from, or lent to, employees, i.e., subtracting hours borrowed from employees and adding hours lent to employees.

Moreover, the capacity planning system 150 may improve the accuracy of the capacity report by further considering additional time that employees need to spend on managerial functions other than the tasks or subtasks, such as taking training classes, attending meetings, performing supervisory work, performing administrative work, etc. The average time spent on managerial functions can be determined based on statistical data or historical of the clearing firm. The average number of hours needed to spend on the managerial functions may be stored in, and obtained from, the employee database 108. The total adjusted work hours can be calculated using the following equation:
Adjusted Total Work Hours=Total Work Hours−Managerial Function Time;
wherein:
Managerial Function Time=(average daily hours lost due to managerial functions*the number of days within the specific period of time)
Alternatively, the managerial function time may be calculated as the actual work time lost due to managerial functions for all employees during a specific period of time.

Thus, according to one embodiment of the disclosure, the capacity planning system 150 calculates the total work hours based on the adjustments as discussed above:

Adjusted Total Work Hours=(Total Work Hours−Managerial Function Time−Staff Outage Time−Managerial Function Time)The capacity planning system 150 may calculate extended staff availability by considering extended work hours using different over-time scenarios and/or expanded staff scenarios, such as borrowing staff from other departments. The extended staff availability allows managers to evaluate whether staff availability is sufficient to handle the workload if extended work hours are used. Forecasts for additional work hours can be calculated based on different scenarios involving different classes and/or types of employees, work schedules, amount of work hours, etc. One example may use the following scenarios:
8-hour Day Non-exempt: non-exempt employees working an additional hour per day
9-hour Day Exempt: non-exempt employees working an additional hour, and exempt employees working two additional hours per day.
Weekend Hours: 5-hour work schedule on Saturdays for four weeks.
   Similar to the staff availability as discussed earlier, the extended staff availability can be calculated as the number of work hours using the following equation:
   Total Work Hours under Extended Staff Availability=total number of employees*(daily work hours+extended work hours under various over-time scenarios)
   (3) Generating Capacity Report

After the workload and staff availability have been determined, the capacity planning system generates a capacity report 151 by comparing the workload and the staff availability, and optionally the extended staff availability. Various warnings may be generated based on the comparisons. For example, a code yellow may be triggered if the existing workload needs employees to work under one of various over-time scenarios, and a code red may be generated if the staff is insufficient to handle the workload even after the extended staff availability is taken into consideration.

In generating the capacity report 151, the capacity planning system 150 may include information related to cost analysis. For example, indices related to the labor cost per unit of each subtask can be calculated by dividing the total employee salaries with the number of subtasks handled during a specific period of time.

The capacity planning system 150 may also provide a capacity forecast report 152 that evaluates the capacity of the clearing firm to handle incoming tasks for the future. The estimated workload may be calculated by the knowledge database 110 based on historical work data with respect to different attributes, such as market status, seasonal factors, holidays, dividend announcements, new business, etc. The capacity planning system 150 may then generate forecast reports using the methods as described above.

(4) Calculating Confidence index

As discussed previously, data to be processed by the organization comes from different sources using various methods, which have varying trustworthiness. As the trustworthiness of the data varies, the reliability of information provided in the capacity reports will be affected by the sources of data. In order to evaluate the trustworthiness of the information included in the capacity reports, a confidence index is provided to indicate the reliability of reports for a specific task.

As discussed earlier, data entered into the capacity planning system 150 is “tagged” with their origins or the methods used to generate the data. Thus, the capacity planning system 150 has access to information related to the sources of data or methods by which the data is entered. In order to calculate a confidence index, in one embodiment, different data sources or points of intake are assigned different trustworthiness scores based on the reliability of data generated by such data sources or points of intake. For example, three trustworthiness scores (3=high, 2=medium, 1=low) can be assigned to the data sources based on their respective confidence levels. Data that is captured automatically may be assigned a high trustworthiness score, while data entered manually or including estimations or large variances may be assigned a lower trustworthiness score. Medium trustworthiness score is assigned when the source is semi-automated and requires manual manipulation to capture/collect the data. More or less levels of trustworthiness scores can be used based on system design preferences.

The capacity planning system 150 has access to information related to relationships between data sources or generating methods and their respective trustworthiness scores. FIG. 2g shows a lookup table depicting a relationship between data sources and their respective trustworthiness scores. Thus, based on the source of data related to each task and the data table shown in FIG. 2g, the capacity planning system 150 determines a confidence index of the task as the trustworthiness score assigned to the data source or generating method that generates the data related to the task. For example, a task with data generated by a data source having a 3.0 trustworthiness score indicates that the estimations for that task, including the workload and/or needed staff are highly trustworthy. On the other hand, a task with a 1.0 trustworthiness score may indicate that the estimations should be subject to scrutiny because the data may contain errors. According to another example, the use of the lookup table is eliminated by having all incoming data tagged with a trustworthiness score which is pre-assigned to each data source or method generating the data. Thus, the capacity planning system 150 is able to retrieve information related to trustworthiness scores directly from the incoming data without using an additional lookup table.

For tasks including data coming from different data sources or generated using different methods, the confidence index is a normalized trustworthiness score calculated based on the respective trustworthiness scores of the data sources and/or the methods that generate the data. For instance, if the data for a specific task comes from the following sources:

| | | trustworthiness | needed |
|---|---|---|---|
| data | data source | score | hours |
| data 1 | DS 1 | 3 | 4.0 |
| data 2 | DS2 | 1 | 2.0 |
| data 3 | DS3 | 2 | 2.0 |
| data 4 | DS2 | 1 | 2.0 |

The normalized trustworthiness score is calculated using the following equation:
normalized trustworthiness score=(sum of (normalized workload*trustworthiness score) (1)
wherein:
the normalized workload=needed work hours/total needed work hours
Thus, in this example, the normalized trustworthiness score of the task is 3*4/10+1*2/10+2*2/10+1*2/10=2.0. Accordingly, the confidence index of the task is 2.0.

Similarly, for a task comprising a plurality of subtasks, or a task including a plurality of other tasks that involve data generated form different data sources and/or by different methods, the confidence index is a normalized trustworthiness score using the same method as illustrated above.

The confidence index allows a reviewer of the capacity report generated by the capacity planning system 150 to evaluate the trustworthiness of the report. For instance, if two tasks, task A and task B, both request 30 hours of work performed by full-time employees, the respective confidence indices of the tasks would give the reviewer an indication of data integrity. If task A has 90% of volumes collected systematically with a confidence index of 2.5, it is reasonable to assume that 30 hours of work performed by full-time employees are realistic. If task B has a confidence index of 1.2, with 10% of volumes collected systematically and 90% of task B's data collected through tick sheets and estimations, there is less integrity of data to back up the request for 30 hours of work performed by full-time employees.

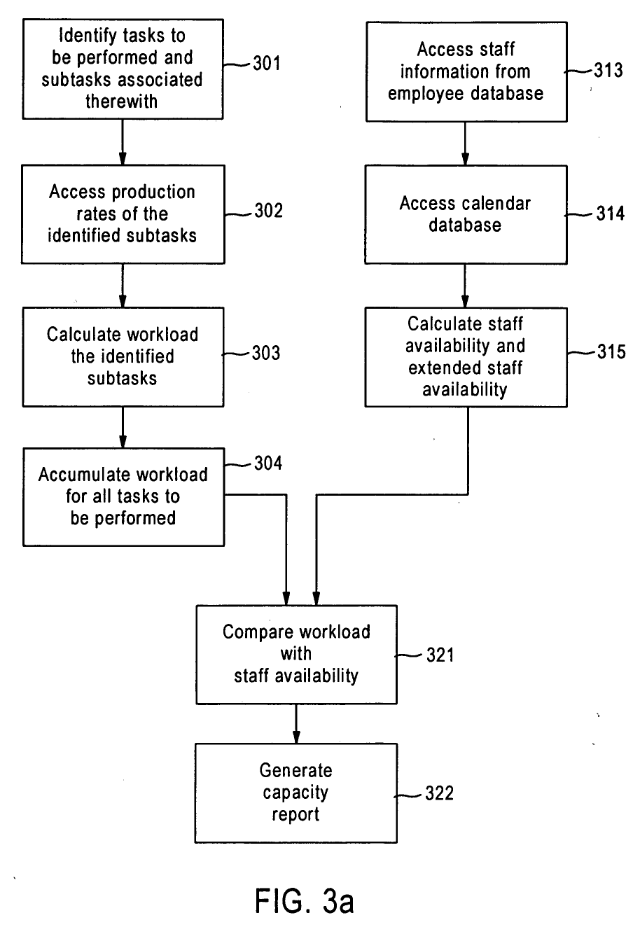

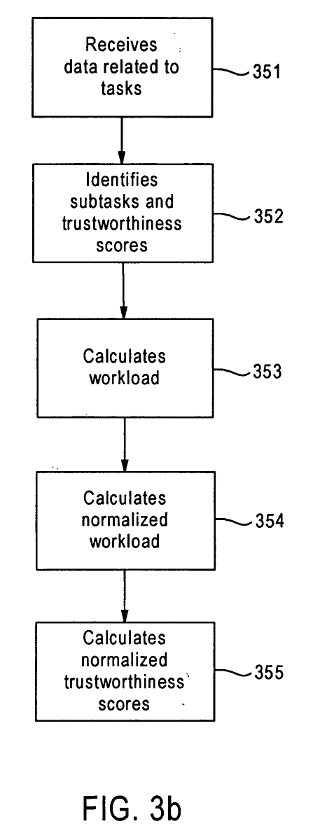

FIG. 3a depicts a flow chart illustrating the operation process of the capacity planning system 150 in generating a capacity report. In Step 301, the capacity planning system 150 receives data related to tasks from data input 102 as well as holdover database 112. In Step 302, the capacity planning system 150 identifies subtasks associated with the tasks as well as their respective production rates by accessing the subtask database 104. In Steps 303 and 304, based on the obtained information, the capacity planning system 150 calculates workload using the methods as discussed above.

In calculating staff availability, the capacity planning system 150 accesses staff information from employee database 108 and calendar information from the calendar database (Steps 313 and 314). After such information is obtained, the capacity planning system 150 calculates staff availability and optionally extended staff availability (Step 305). In Step 321, the capacity planning system 150 compares the workload, staff availability, and generates a capacity report as discussed above (Step 322).

The capacity planning system 150 as described above may be used to dynamically track the volume of incoming tasks in real time and determine whether an organization has sufficient staff to handle the incoming tasks at any given time. The capacity planning system may also be used to generate capacity reports for an extended period of time to determine whether new employees or additional workers need to be brought in. The system also provides forecast on future workload and staff availability.

FIG. 3b depicts a flow chart showing a process of determining a normalized trustworthiness score of a task involving data generated from different data sources. In Step 351, the capacity planning system 150 receives data related to tasks from data input 102 and/or holdover database 112. In Step 352, the capacity planning system 150 identifies subtasks associated with the tasks as well as the respective trustworthiness scores associated with the data sources or methods generating the data involved in each subtask. In Step 353, the capacity system 150 calculates workload using the methods as discussed above. The capacity system 150 then calculates a normalized workload for each subtask in Step 354. In Step 355, the capacity system 150 determines a normalized trustworthiness score for the task by using equation (1). The normalized trustworthiness score is included in the capacity report such that a reviewer of the report can evaluate the trustworthiness of the information included in the report.

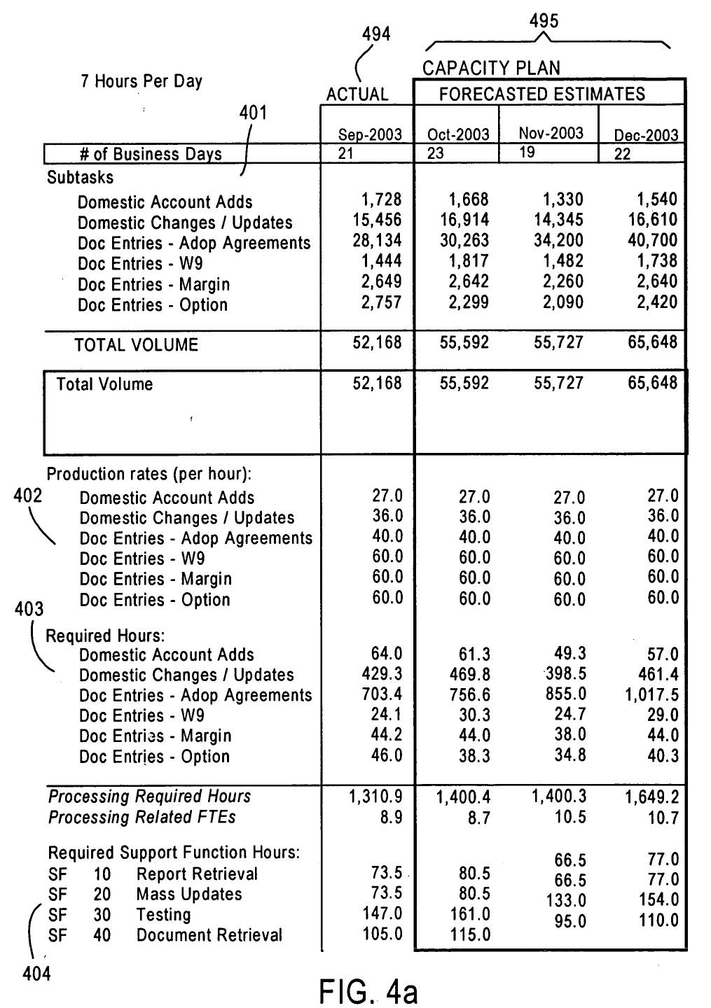

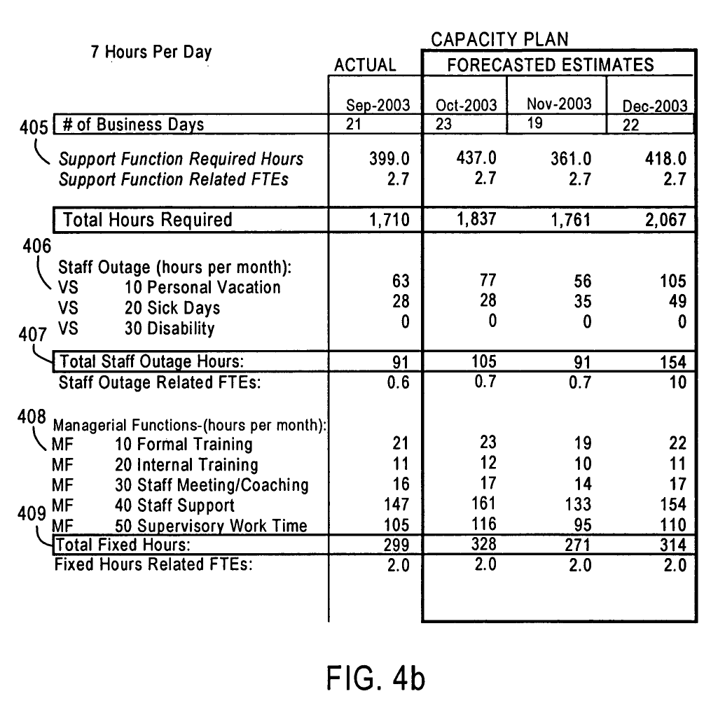

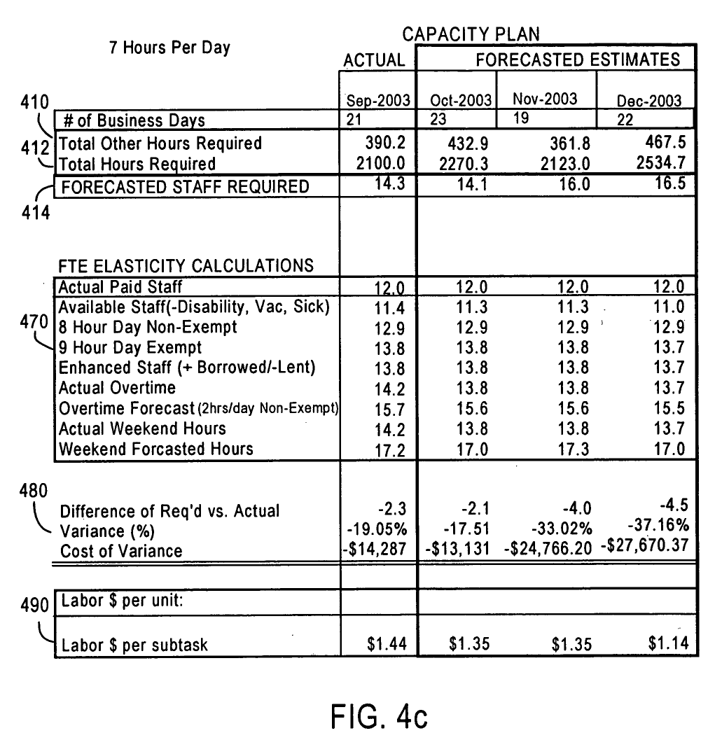

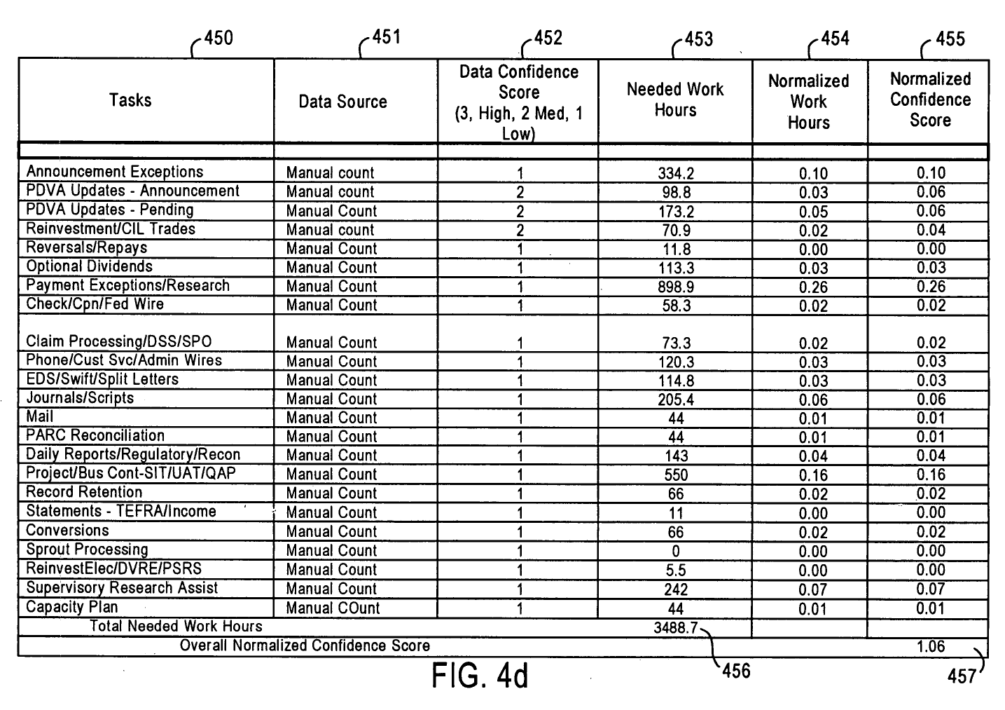

FIGS. 4a-4d shows an exemplary capacity report generated by the capacity planning system as described above, using a seven work hour day scenario. In FIG. 4a, area 494 includes data for September 2003, and area 495 contains forecast data corresponding to October, November and December 2003. Area 401 lists exemplary subtasks to be performed by an organization, including adding domestic account, document entries, etc. The numbers to the right of the area 401 show the number of subtasks to be performed in the respective month. As shown in FIG. 4a, the total number of subtasks for September 2003 is 52,168.

Area 402 lists the production rates for various subtasks listed in area 401. In this example, the production rate is defined as the number of subtasks can be performed per hour. In area 403, the required hours for performing each subtask are shown. The number is obtained by dividing the number of subtasks by their respective production rates. Thus, in September, the total amount of work hours for “domestic account adds” are 64 work hours. Area 403 also shows the total number of work hours required for performing the subtasks, i.e., workload, as 1310.9 hours in September, which is comparable to the work hours of 8.9 full-time employees (FTEs).

Area 404 lists the required Support Function hours including report retrieval, data updates, and testing and document retrieval. In FIG. 4b, area 405 shows the total number of hours needed to perform support functions. For September, the total hours for support function are 399 hours, which is comparable to the work hours of 2.7 full-time employees (FTEs). Areas 406, 407, 408, 409 show the hours lost due to staff outage and performing managerial functions, respectively.

In FIG. 4c, area 410 shows the total number of work hours needed for functions other than performing the subtasks. The number is obtained by adding the hours lost due to staff outage (area 407) and managerial functions (area 409). Area 412 includes information related to total hours needed to perform the subtasks (area 403) and support functions (area 405). In this example, the total work hours needed for September 2003 is 2150 hours (1710 hr+390 hr). Area 414 indicates that the total work hours needed for September 2003 are comparable to the work hours of 14.3 full-time employees (FTEs).

In FIG. 4c, area 470 shows data related to staff availability as well as extended staff availability under different over-time scenarios. As seen in area 470, the actual number of paid staff for September 2003 is 12, and available staff (after taking staff outage into consideration) is 11.4. Extended staff availability under 8-hour day non-exempt and 9-hour day exempt scenarios is 12.9 and 13.8, respectively. Apparently, in September, the staff availability (11.4 FTE) is not sufficient to handle the workload (which needs 14.3 FTE).

Area 480 includes information related to variance of the staff availability, which is defined as the difference between the number of required FTE and actual paid staff, and divided by the number of actual paid staff. Area 480 also includes information related to cost of variance in staff availability, which indicates the monthly cost to fill the staff shortage. For example, if the annual salary of a full-time employee is 75,000, the cost of variance is (−2.3*75000/12=−$14287, for September 2003). In area 490, an index related to monthly labor cost per subtask is provided. The index is obtained by calculating the total monthly salaries of the actual paid employees, and dividing the result by the total number of subtasks.

FIG. 4d depicts an example report showing a confidence index of a task comprising numerous subtasks listed in area 450. Area 451 lists respective data sources of the subtasks shown in area 450. Area 452 includes trustworthiness score of each subtask. Total work hours needed for each subtask are listed in area 453. A total work hours needed for the task is calculated by adding all the needed hours for each subtasks, and shown in area 456. In this example, the total work hours needed for the task is 3488.7 hours. As discusses previously, normalized work hours for each subtask are calculated by dividing the needed work hours for each subtask with the total needed work hours. The normalized work hours for the subtasks are listed in area 454. In area 455, a normalized trustworthiness score for each subtask is calculated by multiplying the trustworthiness score of each subtask with their respective normalized work hours. The result is listed in area 455. An overall normalized trustworthiness score, which represents the confidence index of the task, is calculated by adding all the normalized trustworthiness score for each subtask shown in area 455. In this example, as shown in area 457, the overall normalized trustworthiness score of the task is 1.06. Based on this overall normalized trustworthiness score, a reviewer can evaluate whether the needed work hours for the task (in this example, 3488.7 hours) is trustworthy, and whether additional investigation is needed. This confidence index (in this example, 1.06 out of possible 3.0) also provides a vehicle for reviewers to evaluate whether the data collection processes for this task need improvement to enhance reliability.

Preferred embodiments of the hardware for the capacity planning systems utilize general purpose computers in the form of servers or host computers or in the form of personal computers (PCs). It is presumed that readers are familiar with the structure and operation of these various electronic devices. However, for completeness, it may be helpful to provide a summary discussion here of exemplary general purpose computers.

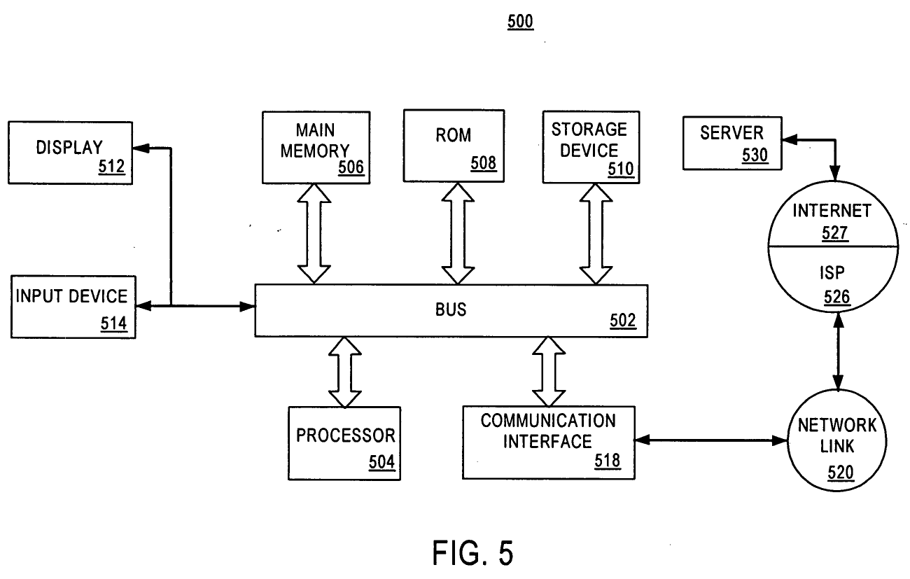

FIG. 5 shows a block diagram of an exemplary data processing system 500 upon which the capacity planning system 150 and/or the system represented by box 100 may be implemented. The data processing system 500, which may be used to implement the capacity planning system 150 and/or the system represented by box 100, includes a bus 502 or other communication mechanism for communicating information, and a data processor 504 coupled with bus 502 for processing data. The data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by data processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions. The data processing system 500 and/or any of the sensors and/or terminals may also have suitable software and/or hardware for converting data from one format to another. An example of this conversion operation is converting format of data available on the system 5 to another format, such as a format for facilitating transmission of the data.

The data processing system 500 may be coupled via bus 502 to a display 512, such as a cathode ray tube (CRT) or liquid crystal display (LCD), for displaying information to an operator. An input device 514, including alphanumeric and other keys, is coupled to bus 502 for communicating information and command selections to processor 504. Another type of user input device is cursor control (not shown), such as a mouse, a touch pad, a trackball, or cursor direction keys and the like for communicating direction information and command selections to processor 504 and for controlling cursor movement on display 512.

The data processing system 500 is controlled in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the disclosed capacity planning. Thus, capacity planning embodiments are not limited to any specific combination of hardware circuitry and software. Those skilled in the art will recognize that the computer system 500 may run other programs and/or host a wide range of software applications, including one or more used in performance of a company's normal operation tasks, which were analyzed by the capacity planning system.

The term “machine readable medium” as used herein refers to any medium that participates in providing instructions to processor 504 for execution or providing data to the processor 504 for processing. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502 or an external network. Transmission media can also take the form of acoustic or light waves, such as those generated during radio wave and infrared data communications, which may be carried on the links of the bus or network.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 504 for execution. For example, the instructions may initially be carried on a magnetic disk of a remote data processing system, such as a server. The remote data processing system can load the instructions into its dynamic memory and send the instructions over a telephone line using a modem. A modem local to data processing system 500 can receive the data on the telephone line and use an infrared transmitter to convert the data to an infrared signal. An infrared detector can receive the data carried in the infrared signal and appropriate circuitry can place the data on bus 502. Of course, a variety of broadband communication techniques/equipment may be used. Bus 502 carries the data to main memory 506, from which processor 504 retrieves and executes instructions and/or processes data. The instructions and/or data received by main memory 506 may optionally be stored on storage device 510 either before or after execution or other handling by the processor 504.

Data processing system 500 also includes a communication interface 518 coupled to bus 502. Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a wired or wireless local area network (LAN) card to provide a data communication connection to a compatible LAN. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network to data equipment operated by an Internet Service Provider (ISP) 526. ISP 526 in turn provides data communication services through the world wide packet data communication network now commonly referred to as the Internet 527. Local network and Internet 527 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

The data processing system 500 can send messages and receive data, including program code, through the network(s), network link 520 and communication interface 518. In the Internet example, a server 530 might transmit a requested code for an application program through Internet 527, ISP 526, local network and communication interface 518. The program, for example, might implement capacity planning, as outlined above. The communications capabilities also allow loading of relevant data into the system, for processing in accord with the capacity planning application.

The data processing system 500 also has various signal input/output ports for connecting to and communicating with peripheral devices, such as printers, displays, etc. The input/output ports may include USB port, PS/2 port, serial port, parallel port, IEEE-1394 port, infra red communication port, etc., and/or other proprietary ports. The data processing system 500 may communicate with other data processing systems via such signal input/output ports.

Although currently the most common type, those skilled in the art will recognize that the PC is only one example of the types of data processing systems a user may operate to communicate via the Internet. Other end-user devices include portable digital assistants (PDAs) with appropriate communication interfaces, cellular or other wireless telephone devices with web or Internet access capabilities, web-TV devices, etc.

Additional variations to the capacity planning system are available. For instance, when calculating the total amount of time lost due to managerial functions, a more precise method may be used rather than using statistical measures or historical data. As discussed earlier relative to FIG. 2c, the staff information stored in the employee database 108 includes information related to hours that a specific employee cannot be used to perform the subtasks. Such lost time varies from employee to employee due to their respective positions, administrative responsibilities and/or other duties. Thus, when accessing the staff information, the capacity planning system 150 may accumulate the unavailable hours of each employee to generate an accurate number of amount of time lost due to managerial functions, rather just an estimate obtained from historical statistics.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

1. A capacity planning method comprising the steps of:
receiving data related to a task;
accessing a trustworthiness score associated with the data;
calculating a workload of the task based on the data;
calculating a confidence index of the task based on the trustworthiness score; and
generating a capacity report based on the workload and the confidence index of the task.

2. The method of claim 1 further comprising the steps of:
accessing staff information; and
determining staff availability based on the staff information;
wherein the capacity report is generated based on the workload and the staff availability.

3. The method of claim 1, wherein the trustworthiness score associated with the data is determined based on a data source or a method that generates the data.

4. A data processing system for capacity planning comprising:
a processor for processing data;
a data storage device coupled to the processor;
the data storage device bearing instructions to cause the data processing system to perform the steps of:
receiving data related to a task;
accessing a trustworthiness score associated with the data related to the task;
calculating a workload for the task based on the data related to the task;
calculating a confidence index based on the trustworthiness score; and
generating a capacity report based on the workload and the confidence index of the task.

5. The system of claim 4, wherein the data storage device further stores instructions that, when executed by the data processor, control the data processing system to perform the further steps of:
accessing staff information; and
determining staff availability based on the staff information;
wherein the capacity report is generated based on the workload and the staff availability.

6. The system of claim 4, wherein the trustworthiness score associated with the data related to the task is determined based on a data source or a method that generates the data related to the task.

7. A program comprising instructions, which may be embodied in a machine-readable medium, for controlling a data processing system to perform capacity planning, the instructions upon execution by the data processing system causing the data processing system to perform the steps comprising:
receiving data related to a task;
accessing a trustworthiness score associated with the data related to the task;
calculating a workload of the task based on the data related to the task;
calculating a confidence index based on the trustworthiness score; and
generating a capacity report based on the workload and the confidence index of the task.

8. The program of claim 7 further includes instructions that, when executed by the data processing system, control the data processing system to perform the further steps of:
accessing staff information; and
determining staff availability based on the staff information;
wherein the capacity report is generated based on the workload and the staff availability.

9. The program of claim 7, wherein the trustworthiness score associated with the data related to the task is determined based on a data source or a method that generates the data related to the task.

10. A capacity planning method for generating a capacity report for a plurality of tasks, the method comprising the steps of:
receiving data related to each of the plurality of tasks;
accessing a trustworthiness score associated with the data related to each of the plurality of tasks;
calculating a workload for each of the plurality of tasks;
calculating a confidence index for the plurality of tasks based on the trustworthiness scores of the plurality of tasks; and
generating the capacity report based on the workload for each of the plurality of tasks and the confidence index.

11. The method of claim 10, wherein the step of calculating the confidence index comprises the steps of:
calculating a normalized trustworthiness score of each of the plurality of tasks; and
generating the confidence index based on the normalized trustworthiness scores of the plurality of tasks.

12. The method of claim 11, wherein the step of calculating the normalized trustworthiness score of each of the plurality of tasks comprises the steps of:
calculating a relative workload of each of the plurality of tasks based on the workload of each of the plurality of tasks relative to the total workload of the plurality of tasks; and
generating the normalized trustworthiness score for each of the plurality of tasks based on the trustworthiness score of each of the plurality of tasks, and the relative workload of each of the plurality of tasks.

13. The method of claim 12, wherein:
the relative workload is calculated by dividing the workload of each of the plurality of tasks by the total workload of the plurality of tasks; and
the normalized trustworthiness score for each of the plurality of tasks is generated by multiplying the trustworthiness score of each of the plurality of tasks, by the relative workload of each of the plurality of tasks.

14. The method of claim 13, wherein the confidence index is generated by combining the normalized trustworthiness score for each of the plurality of tasks.

15. The method of claim 14, wherein the confidence index is generated by adding the normalized trustworthiness score for each of the plurality of tasks.

16. The method of claim 10, wherein the trustworthiness score associated with the data related to each of the plurality of tasks is determined based on a data source or a method that generates the data related to each of the plurality of tasks.

17. A data processing system for generating a capacity report for a plurality of tasks, the system comprising:
a processor for processing data;
a data storage device coupled to the processor;
the data storage device bearing instructions to cause the data processing system upon execution of the instructions by the processor to perform the steps of:
receiving data related to each of the plurality of tasks;
accessing a trustworthiness score associated with the data related to each of the plurality of tasks;
calculating a workload for each of the plurality of tasks;
calculating a confidence index for the plurality of tasks based on the trustworthiness scores of the plurality of tasks; and
generating the capacity report based on the workload of each of the plurality of tasks and the confidence index.

18. The method of claim 17, wherein the step of calculating the confidence index comprises the steps of:
calculating a normalized trustworthiness score of each of the plurality of tasks; and
generating the confidence index based on the normalized trustworthiness scores of the plurality of tasks.

19. The system of claim 18, wherein the step of calculating the normalized trustworthiness score of each of the plurality of tasks comprises the steps of:
calculating a relative workload of each of the plurality of tasks based on the workload of each of the plurality of tasks relative to the total workload of the plurality of tasks; and
generating the normalized trustworthiness score for each of the plurality of tasks based on the trustworthiness score of each of the plurality of tasks, and the relative workload of each of the plurality of tasks.

20. The system of claim 19, wherein:
the relative workload is calculated by dividing the workload of each of the plurality of tasks by the total workload of the plurality of tasks; and
the normalized trustworthiness score for each of the plurality of tasks is generated by multiplying the trustworthiness score of each of the plurality of tasks by the relative workload of each of the plurality of tasks.

21. The system of claim 20, wherein the confidence index is generated by combining the normalized trustworthiness score for each of the plurality of tasks.

22. The system of claim 21, wherein the confidence index is generated by adding the normalized trustworthiness score for each of the plurality of tasks.

23. The system of claim 17, wherein the trustworthiness score associated with the data related to each of the plurality of tasks is determined based on a data source or a method that generates the data related to each of the plurality of tasks.

24. A program comprising instructions, which may be embodied in a machine-readable medium, for controlling a data processing system to perform capacity planning, the instructions upon execution by the data processing system causing the data processing system to perform the steps comprising:
receiving data related to each of the plurality of tasks;
accessing a trustworthiness score associated with the data related to each of the plurality of tasks;
calculating a workload for each of the plurality of tasks;
calculating a confidence index based on the trustworthiness score of each of the plurality of tasks; and
generating the capacity report based on the workload of each of the plurality of tasks and the confidence index.

25. The program of claim 24, wherein the step of calculating the confidence index comprises the steps of:
calculating a normalized trustworthiness score of each of the plurality of tasks; and
generating the confidence index based on the normalized trustworthiness scores of the plurality of tasks.

26. The program of claim 25, wherein the step of calculating the normalized trustworthiness score of each of the plurality of tasks comprises the steps of:
calculating a relative workload of each of the plurality of tasks based on the workload of each of the plurality of tasks relative to the total workload of the plurality of tasks; and
generating the normalized trustworthiness score for each of the plurality of tasks based on the trustworthiness score of each of the plurality of tasks, and the relative workload of each of the plurality of tasks.

27. The program of claim 26, wherein:
the relative workload is calculated by dividing the workload of each of the plurality of tasks by the total workload of the plurality of tasks; and
the weighted average trustworthiness score for each of the plurality of tasks is generated by multiplying the trustworthiness score of each of the plurality of tasks by the relative workload of each of the plurality of tasks.

28. The program of claim 27, wherein the confidence index is generated by combining the normalized trustworthiness score for each of the plurality of tasks.

29. The program of claim 28, wherein the confidence index is generated by adding the normalized trustworthiness score for each of the plurality of tasks.

30. The program of claim 24, wherein the trustworthiness score associated with the data related to each of the plurality of tasks is determined based on a data source or a method that generates the data related to each of the plurality of tasks.

31. A capacity planning method comprising the steps of:
receiving a plurality sets of data related to a task;
accessing a trustworthiness score associated with each of the plurality sets of data;
calculating a workload related to each of the plurality sets of data based on each of the plurality sets of data;
calculating a confidence index for the task based on the trustworthiness scores associated with the plurality sets of data; and
generating a capacity report for the task based on the workload and the confidence index.

32. The method of claim 31, wherein the step of calculating the confidence index comprises the steps of:
calculating a normalized trustworthiness score for each of the plurality sets of data; and
generating the confidence index based on the normalized trustworthiness scores of the plurality sets of data.

33. The method of claim 32, wherein the step of calculating the normalized trustworthiness score of each of the plurality of tasks comprises the steps of:
calculating a relative workload for each of the plurality sets of data based on the workload for each of the plurality sets of data relative to the total workload of the task; and
generating the normalized trustworthiness score for each of the plurality sets of data based on the trustworthiness score of each of the plurality sets of data, and the relative workload of each of the plurality sets of data.

34. The method of claim 33, wherein:
the relative workload is calculated by dividing the workload of each of the plurality sets of data by the total workload of the task; and
the normalized trustworthiness score for each of the plurality sets of data is generated by multiplying the trustworthiness score of each of the plurality sets of data, by the relative workload of each of the plurality sets of data.

35. The method of claim 34, wherein the confidence index is generated by combining the normalized trustworthiness score for each of the plurality sets of data.

36. The method of claim 35, wherein the confidence index is generated by adding the normalized trustworthiness score for each of the plurality sets of data.

37. The method of claim 31, wherein the trustworthiness score associated with each of the plurality sets of data is determined based on a data source or a method that generates the respective sets of data.

38. A program comprising instructions, which may be embodied in a machine-readable medium, for controlling a data processing system to perform capacity planning, the instructions upon execution by the data processing system causing the data processing system to perform the steps comprising:
receiving a plurality sets of data related to a task;
accessing a trustworthiness score associated with each of the plurality sets of data;
calculating a workload based on each of the plurality sets of data;
calculating a confidence index of the task based on the trustworthiness score associated with each of the plurality sets of data; and
generating a capacity report for the task based on the workload and the confidence index.

39. The program of claim 38, wherein the step of calculating the confidence index comprises the steps of:
calculating a normalized trustworthiness score for each of the plurality sets of data; and
generating the confidence index based on the normalized trustworthiness scores of the plurality sets of data.

40. The program of claim 39, wherein the step of calculating the normalized trustworthiness score of each of the plurality of tasks comprising the steps of:
calculating a relative workload for each of the plurality sets of data based on the workload for each of the plurality sets of data relative to the total workload of the task; and
generating the normalized trustworthiness score for each of the plurality sets of data based on the trustworthiness score of each of the plurality sets of data, and the relative workload of each of the plurality sets of data.

41. The program of claim 40, wherein:
the relative workload is calculated by dividing the workload of each of the plurality sets of data by the total workload of the task; and
the normalized trustworthiness score for each of the plurality sets of data is generated by multiplying the trustworthiness score of each of the plurality sets of data, by the relative workload of each of the plurality sets of data.

42. The program of claim 41, wherein the confidence index is generated by combining the normalized trustworthiness score for each of the plurality sets of data.

43. The program of claim 42, wherein the confidence index is generated by adding the normalized trustworthiness score for each of the plurality sets of data.

44 The program of claim 38, wherein the trustworthiness score associated with each of the plurality sets of data is determined based on a data source or a method that generates the respective sets of data.

45. A capacity planning method comprising the steps of:
identifying each of a plurality of tasks to be performed;
identifying subtasks associated with each of the identified tasks;
accessing production rate information related to a relationship between the amount of time or the number of staff needed to perform each of the identified subtasks;
calculating a workload based on the identified subtasks and the production rate information;
accessing staff information;
determining staff availability based on the staff information; and
generating a capacity report based on the workload and the staff availability;
wherein the identified of tasks include at least one holdover task.

46. The method of claim 45 further including a step of accessing information related to the at least one holdover task from a holdover database.

47. The capacity planning method of claim 45, wherein the workload is calculated as the number of fulltime employees needed to perform the identified subtasks, based on standard work hours per day.

48. The capacity planning method of claim 45, wherein the staff information includes at least one of information related to the number of employees, information related to identities and positions of employees, information related to exempt status of employees, information related to staff outage, information related to work time that cannot be used to perform the subtasks, and information related to business days within a specific period of time.

49. The capacity planning method of claim 48, wherein the staff availability is calculated based on the workload, the number of employees, the information related to staff outage, the information related to the amount of work time that cannot be used to perform the subtasks, and the information related to business days.
